(19) United States
(12) Patent Application Publication
(10) Pub. No.: US 2007/0172557 A1
(43) Pub. Date: Jul. 26, 2007

(54) Oxygen scavenger fitment assembly

(76) Inventor: Rodney J. Simpson, Batavia, IL (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 11/655,439

(22) Filed: Jan. 19, 2007

Related U.S. Application Data
(60) Provisional application No. 60/760,682, filed on Jan. 20, 2006.

(51) Int. Cl. A23B 7/148

(52) U.S. Cl. 426/106

(57) ABSTRACT

An oxygen scavenging material (e.g., ferrous metal and inorganic salt compound disk, powder, or pellets) is, placed in a plastic fitment assembly, which then is applied, for example, by heat to the sealant side of film, while on a horizontal or vertical pouch forming equipment. The fitment is designed to hold the disk or pellets in place using a porous film and/or the fitment itself. The inside fitment is snapped into the outside fitment, now called the fitment assembly. The fitment assembly is sealed using the outer fitment to the packaging film material. The porous film allows the oxygen to be absorbed by the ferrous and salt compound (disk, powder, or pellets). The plastic fitment assembly is applied to the headspace area of the package and sealed into place. The fitment assembly is in the headspace area, which is the ideal location for oxygen absorption.

### CROSS-REFERENCE TO RELATED APPLICATIONS

This application claims benefit of U.S. provisional application Ser. No. 60/760,682 filed Jan. 20, 2006, entitled “Oxygen Scavenger Fitment Assembly”, the disclosure of which is expressly incorporated herein by reference.

### STATEMENT REGARDING FEDERALLY SPONSORED RESEARCH

Not applicable.

### BACKGROUND OF THE INVENTION

The present invention generally relates to packaging for foodstuffs and more particularly to scavenging oxygen from within such packaging which otherwise is deleterious to the foodstuffs and it storage.

Oxygen scavengers are used today to reduce residual oxygen in a barrier package to inhibit growth of of aerobic microorganisms, prevent mold growth, and to maintain product color, taste, flavor, and nutritive elements. Oxygen scavengers are used with both dry foods and moist foods, and are used to reduce both oxygen and carbon dioxide within the package. Reducing oxygen in the food package allows the product quality to be extended beyond what the modified atmosphere process allows. Normal atmosphere contains about 21% oxygen. Modification of the atmosphere by flushing the package contents with an inert gas (e.g., nitrogen or carbon dioxide/nitrogen mix) can reduce the oxygen to as low as about 0.5%. The oxygen scavenger is used to reduce the oxygen level to 0.0% and extend the degradation process of the product, thereby extending the shelf life of the product.

Oxygen scavengers in a sachet form are used today for various products, including, inter alia, dried meat products (e.g., beef jerky, pepperoni, etc.), refrigerated pizza crust, lunchmeats, and pasta noodles to extend shelf life of the product. An oxygen scavenger also can be purchased in the form of a sachet, card or label with adhesive backing. Sachets used in food products can pose a legal issue. Adults and children, who are unaware of what a sachet is, can accidentally ingest the sachet during normal consumption of the product, which can be harmful if swallowed. Though there are no reported incidents of ingesting a sachet, it remains a litigation risk.

Labels with ferrous metals (e.g., iron powder) and inorganic salt used to absorb oxygen are limited to the actual amount of the active material on the label. Oxygen scavenging labels for large amounts of product would be too large, too costly, and too bulky for application. Oxygen scavenging labels are used today on small packages of process meats, but at a price of about twice the cost of a sachet.

There is a need, then, for an inexpensive, safer way to scavenge oxygen from packaged foodstuffs for extending the shelf life of the product.

### BRIEF SUMMARY

An oxygen scavenging material (e.g., ferrous metal and-salt compound disk, pellets, powder, etc.) is placed in a plastic fitment assembly, which then is applied, for example, by heat or induction to the sealant side of film, while on a horizontal or vertical pouch forming equipment. The fitment is designed to hold the disk or pellets in place using a porous film. The inside fitment is snapped into the outside fitment, now called the fitment assembly. The fitment assembly is sealed using the outer fitment to the packaging film material. The porous film allows the oxygen to be absorbed by the ferrous metal and salt compound (disk, powder, or pellets).

The plastic fitment assembly is applied to the headspace area of the package and sealed into place. The fitment assembly is in the headspace area, which is the ideal location for oxygen absorption due the requirement of airflow to aide in the uptake of oxygen. Unlike sachets, which fall loosely in with the product and which can alter or “smother” the activation of the sachet ferrous metal and salt compound, the inventive fitment assembly is captured and held in place. In some instances, labels or sachets can come in contact directly with the product, so that it causes product quality to deteriorate somewhat. A very small amount of rust or some other form of iron may be transported to the surface of the label or sachet by such excess fluids and may slightly color the surface of the product. Many of the packages today do not allow a sachet or label to be placed at a location in the package so as not to allow free flow of air within the package, preventing the application to be fully operable.

Advantages of the present invention include a simple, yet reliable means of adding an oxygen scavenger to foodstuff packaging. Another advantage is a fitment assembly that is designed to ensure that the consumer does not accidentally or inadvertently ingest the oxygen scavenger. Yet other advantages may include the elimination of an unsightly presence of a sachet showing through a window of the package on the retail shelf and use in a package where consumers would reject the sight of a sachet as a poor quality product. The fitment assembly also can be placed in pre-made bags, pouches, or other formed packages prior to the fill and seal process with foodstuffs. These and other advantages will be readily apparent to those skilled in the art.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a perspective view of one embodiment of the disclosed fitment assembly containing pellets;

FIG. 2 is a cross-sectional view taken along line 2-2 of FIG. 1;

FIG. 3 is a cross-sectional view of an alternative embodiment of the fitment assembly having two chambers; and

FIG. 4 is a cross-sectional view of yet another embodiment of the disclosed fitment assembly containing a disk.

The drawings will be described in further detail below.

### DETAILED DESCRIPTION

The use of a plastic fitment allows for ideal placement of the interactive oxygen scavenger inside the package. The sealing of the fitment to the inside of the package assures for the safety of the scavenger not to be inadvertently ingested by the consumer.

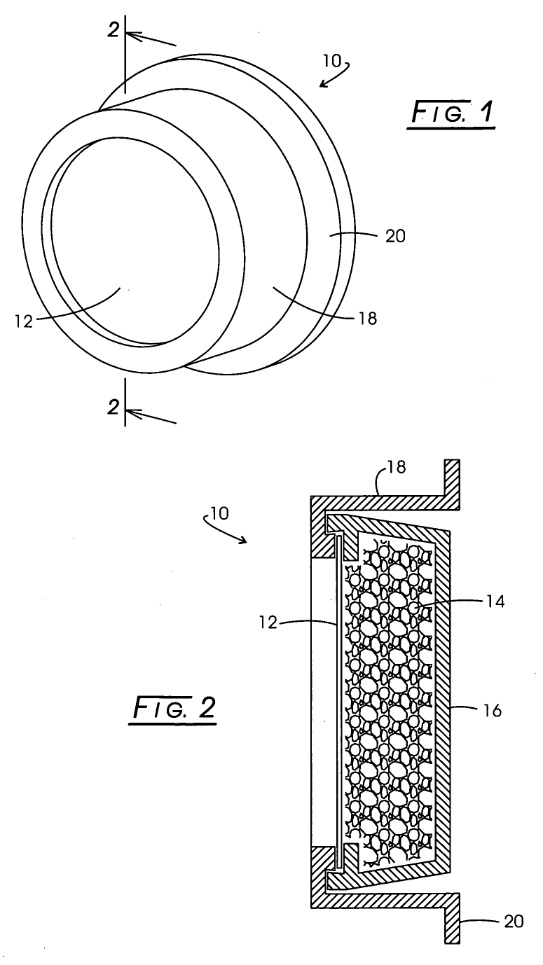

Referring initially to FIGS. 1 and 2, one embodiment of a fitment assembly, 10, is seen to include a membrane film, 12, capable of passing oxygen therethrough, surmount a chamber housing a ferrous compound or other oxygen scavenger material, 14, which can be supplied in particulate form (e.g., pellet) or conveniently in disk form, 24, as illustrated in FIG. 4. The chamber is formed from an inner polymeric fitment, 16, which is held in place by an outer polymeric fitment, 18, which has an outer flange, 20, for sealing to the inside surface of a foodstuff pouch or bag, 22 (see FIG. 4). The fitment assembly conveniently can be any shape, including, for example, round or oblong in shape, as depicted in FIG. 1, where oxygen (usually in the form of air) can enter the fitment assembly through membrane film 12. Additionally, membrane film 12 can be porous to water for its adsorption by oxygen scavenger material 14.

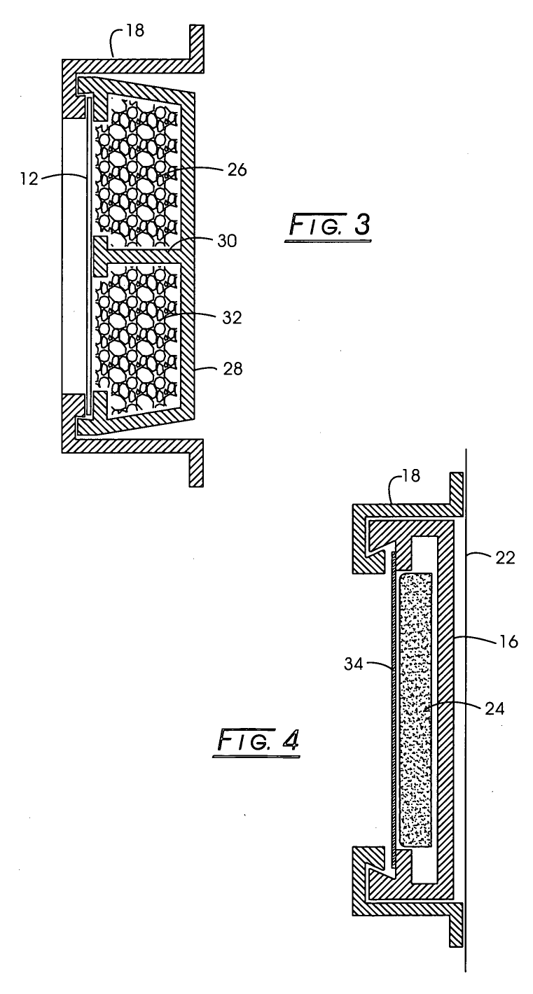

In FIG. 3, an inner fitment, 28, is subdivided into two chambers by an upstanding divider, 30, to form a pair of chambers. One chamber can retain an oxygen scavenging material, 26, such as ferrous pellets, and the second chamber can retain desiccant pellets, 32, for adsorbing moisture. More than two chambers can be formed for housing additional pellets or disks, depending upon the needs of the food packager. Again, a round or oblong shape is illustrated.

FIG. 4 shows the disk embodiment where a porous membrane film, 34, is sealed or held in place to inner fitment 16. Of course, there is no limitation as to the particular form that the oxygen scavenging or desiccant material can take. Pellets and disks merely are shown in the drawings in order to illustrate the invention for the skilled artisan.

Suitable plastics for forming the disclosed fitment assembly include, for example, polypropylene, polyethylene, ethylene copolymer, or any combination of polymers and copolymers suitable for food grade applications and with compatibility to be sealed to the inside of a foodstuff package.

Suitable materials for forming the oxygen permeable membrane include, for example, polyamides, ethylene vinyl alcohol (EVOH), polyvinylidene chloride (PVDC), polyethylene terephthalate (PET), polyvinyl chloride (PVC), polyethylene naphthalate (PEN), polyacrylonitrile (PAN), polyamide films, silica coated films, ethylene vinyl alcohol films, metallized films, foil, nylon/EVOH/nylon films, oriented polypropylene films, oriented polyethylene films, polyester films, and PVDC coated substrates.

Most coffee bags, for example, with whole bean or granule coffee use a One-way Valve to allow for the release of CO₂. Coffee produces CO₂ and will inflate the pouch or bag, causing consumers to pass off the package as poor quality. The One-way Valve is applied to the inside of the pouch or bag during the forming process, exactly like the Oxygen Scavenger Fitment would be applied. The producer of the equipment to allow this fitment to be placed on a pouch or bag forming equipment exists today and can be added to existing machines used in the industry for the meat, pasta, pizza crust, or other oxygen sensitive product applications. Use of a combination of the inventive fitment assembly and one-way valves also is contemplated within the scope of the present disclosure.

Labels, which can also be attached to the inside, have one drawback. They present downtime on the production line. The line attendant must replace the roll of labels frequently, causing higher line labor costs and a less efficient production line. The system used for the inventive assembly is fed from a hopper, which is more reliable, easy to maintain at minimal labor cost and does will not cause excessive machine downtime like a label absorber.

It will be appreciated that almost any packaged foodstuff can have the inventive fitment assembly affixed thereto, in addition to those foodstuffs specifically enumerated herein, such foodstuffs being exemplary in the invention and not a limitation thereon.

Additionally, while plastic or polymeric materials are most likely to be used based on present-day packaging regimens, other materials are possible candidates for use, such as, for example, metals. Oxygen and moisture porous membranes are well known by the skilled artisan. Further, while heat-sealing the fitment assembly to the inner surface of the foodstuff packaging has been illustrated, such fitment assembly association with the foodstuff packaging includes, for example, adhesive attachment and mechanical attachment, for example. All materials in contact with the foodstuff, of course, will be made from appropriate food-grade materials.

While the invention has been described with reference to various embodiments, those skilled in the art will understand that various changes may be made and equivalents may be substituted for elements thereof without departing from the scope and essence of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. An oxygen scavenging fitment assembly, which comprises:
(a) an outer fitment having a flange adapted to be secured to a foodstuff container;
(b) an inner fitment secured by said outer fitment and forming an inner chamber;
(c) an oxygen permeable membrane sealing said inner chamber; and
(d) an oxygen scavenger material housing within said inner chamber.

2. The fitment assembly of claim 1, wherein said outer and inner fitments are formed from a plastic.

3. The fitment assembly of claim 2, wherein said plastic is one or more of high density polyethylene, polypropylene, low density polyethylene, or copolymers of polypropylene and polyethylene.

4. The fitment assembly of claim 1, wherein said oxygen scavenging material comprises a ferrous material in one or more of pellet or disk form.

5. The fitment assembly of claim 1, wherein outer fitment and said inner fitment secured by snapping together.

6. The fitment assembly of claim 1, wherein said inner fitment forms more than one chamber.

7. The fitment assembly of claim 6, wherein one of said chambers contains a desiccant.

8. The fitment assembly of claim 1, wherein said oxygen permeable membrane is formed from one or more of a polyamide, ethylene vinyl alcohol (EVOH), polyvinylidene chloride (PVDC), polyethylene terephthalate (PET), polyvinyl chloride (PVC), polyethylene naphthalate (PEN), polyacrylonitrile (PAN), a silica coated film, a metallized film, foil, a nylon/EVOH/nylon film, an oriented polypropylene film, an oriented polyethylene film, or a polyester film.

9. An improved foodstuff container having an inner chamber for housing a foodstuff, the improvement which comprises: disposing the fitment assembly of claim 1 within said foodstuff inner chamber.

10. The improved foodstuff container of claim 1, wherein said foodstuff chamber is formed from foodstuff container walls and said fitment assembly is secured to a foodstuff container wall.

11. The fitment assembly of claim 1, wherein the oxygen permeable membrane is made of one or more of paper, a polymer, a multilayer polymer structure, or a combination of paper and polymer.

12. The fitment assembly of claim 1, wherein said membrane is secured in place between the outer and inner fitment by force fit during fitment assembly.

13. The fitment assembly of claim 1, wherein said inner fitment has a top rim and said membrane is secured in place by sealing said membrane to said top rim of the inner fitment prior to fitment assembly.

14. The fitment assembly of claim 4, wherein the oxygen scavenging material has an inert porous material surrounding the scavenging material.

15. The fitment assembly of claim 1, wherein the flange has been coated with a sealant aide comprising an adhesive.

16. The fitment assembly of claim 1, wherein one or more of the outer fitment or inner fitment is made by one or more of injection molding or compression molding.

17. The fitment assembly of claim 7, wherein said oxygen scavenging material and said desiccant are supplied as disks.

18. The fitment assembly of claim 7, wherein desiccant and said oxygen scavenging material are supplied as one or more of pellets or disks.

19. In combination, a foodstuff package containing a foodstuff and an oxygen scavenging fitment assembly disposed within said foodstuff package, said oxygen scavenging fitment assembly comprising:
(a) an outer fitment having a flange adapted to be secured to a foodstuff container;
(b) an inner fitment secured by said outer fitment and forming an inner chamber;
(c) an oxygen permeable membrane sealing said inner chamber; and
(d) an oxygen scavenger material housing within said inner chamber.

20. The combination of claim 19, wherein said foodstuff is one or more of a low temperature product, a vacuum packed product, a gas purged product, wherein said foodstuff comprises oxygen sensitive materials or oxygen sensitive components.
